(19) United States
(12) Patent Application Publication
(10) Pub. No.: US 2005/0008004 A1
(43) Pub. Date: Jan. 13, 2005

(54) System for transmitting emergency and notification messages over a phone line

(75) Inventor: Donald A. Williams, (US)

Correspondence Address: ROBERT W STROZIER, P.L.L.C, PO BOX 429, BELLAIRE, TX, 77402-0429, US

(73) Assignee: TELCONCEPT USA HOLDINGS, INC.

(21) Appl. No.: 10/847,633

(22) Filed: May 17, 2004

Related U.S. Application Data
(60) Provisional application No. 60/471,156, filed on May 16, 2003.

(51) Int. Cl. H04L 12/66; H04L 12/28; H04L 12/56

(52) U.S. Cl. 370/352; 370/401

(57) ABSTRACT

A method of communication utilizing the Public Switch Telephone Network (PSTN) and the Internet is disclosed which includes receiving on a database server, a query transmitted from a first computer, which query includes a set of instructions encapsulated in a string of data including a telephone number, time, date and a short fifteen character message that will be accessed by a third computer which is running a telephone soft switch server, the soft switch server will then place a call to the telephone number and deliver the string of data using Frequency Shift Keying (FSK) and SMS even while the recipient's phone is ringing or while off hook as call wait caller id (CWCID).

### RELATED APPLICATIONS

This application claims provisional priority to U.S. Provisional Patent Application Ser. No 60/471156 filed 16 May 2003.

### BACKGROUND OF THE INVENTION

1. Field of the Invention

This invention is related to the general subject of Internet communications and Frequency Shift Key (FSK) signaling systems.

2. Description of the Related Art

Introduction of SS7 switching in central office switching systems provided the technological capability to introduce caller ID services to customers. Caller ID services utilize the ability of a modem call switching and routing system, referred to in the telecommunications industry as a Stored Program Control System (SPCS), to record and provide to a call recipient information regarding the calling party in a Calling Party Number Message (CPN Message). This information, commonly referred to as caller ID information, may comprise the calling party's telephone number or name.

Telephones capable of displaying caller ID information are increasingly common. In fact, caller ID services are one of a group of network-provided enhanced services known as custom local area signaling services (CLASS). Although information is being transmitted to phones (land lines or wireless), the information currently being transmitted is of a limited scope. Moreover, emergency information is currently available only via web browsing or via telephone calls informing the recipient of an emergency condition.

Thus, there is a need in the art for a more full use of this type of information transmission, especially, in military situation, emergency situations or law enforcement situations where emergency coded information or short messages can be forwarded to one or more recipients notifying them of a given emergency condition or anyone who is a designated recipient of the emergency information.

### SUMMARY OF THE INVENTION

The invention provides a method for transmitting emergency and other informative messages or notices, coded or plain text, over a phone line, comprising: installing software into an telephone switch computer or device to enable the telephone switch device to place a telephone call which delivers a short message using Frequency Shift Key (FSK) to a second device that is attached to the telephone line; and wherein the second device includes a caller ID customer premise equipment (CPE) or a modem connected to a computer with software that would enable the user to see (visual) or hear (audible) an alarm related to the message.

In another embodiment the invention comprises a method of communication utilizing the Internet which includes receiving on a server an e-mail message transmitted from a first computer, which email is formatted in such a manner that when received by the email server or the second computer, the second computer is able to filter the message and send a data input transmission to a third server which retrieves the inputted data from a database server and generates a telephone call to a telephone user and to initiate an FSK signal from the third server to a caller ID Customer Premise Equipment (CPE) or a modem connected to a computer; and delivering a short 16 character message to the CPE or modem

### DESCRIPTION OF THE DRAWINGS

The invention can be better understood with reference to the following detailed description together with the appended illustrative drawings in which like elements are numbered the same:

FIG. 1A illustrates a block diagram of a FSK phone response to a call;

FIG. 1A illustrates a block diagram of a CAS phone response to a call;

FIG. 2 illustrates a generalized block diagram of the Internet;

FIG. 3 illustrates a generalized block diagram of the Internet with the Enhancements of this invention;

FIG. 4A shows a display screen useful for composing an e-mail utilizing the present invention; and

FIG. 4B shows a display screen of an e-mail recipient utilizing the present invention.

### DETAILED DESCRIPTION OF THE INVENTION

In accordance with the present invention, normal caller ID and FSK communications service is enhanced to enable a user alert on a CPE without the need to engage the telephone line in a full duplex communication which will deplete the limited network resources of the PSTN or the Wireless Telephone Service Provider (WTSP) in the event of a large scale emergency announcement similar to that required during the terrorist attacks of September 11^{th}. Additional messages may be transmitted using the same method once the telephone is picked up off the Hook in the event that the subsequent messages do not pose a traffic glut threat for the network.

### Phones and Caller ID Implementations

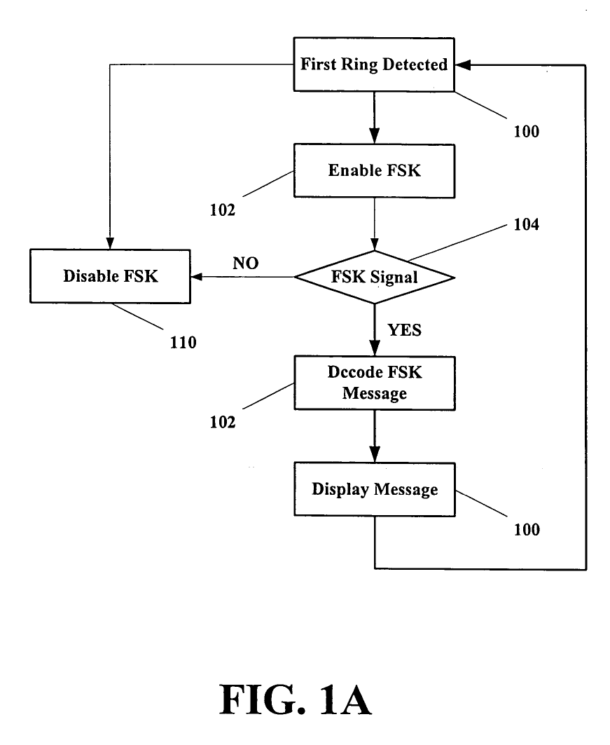

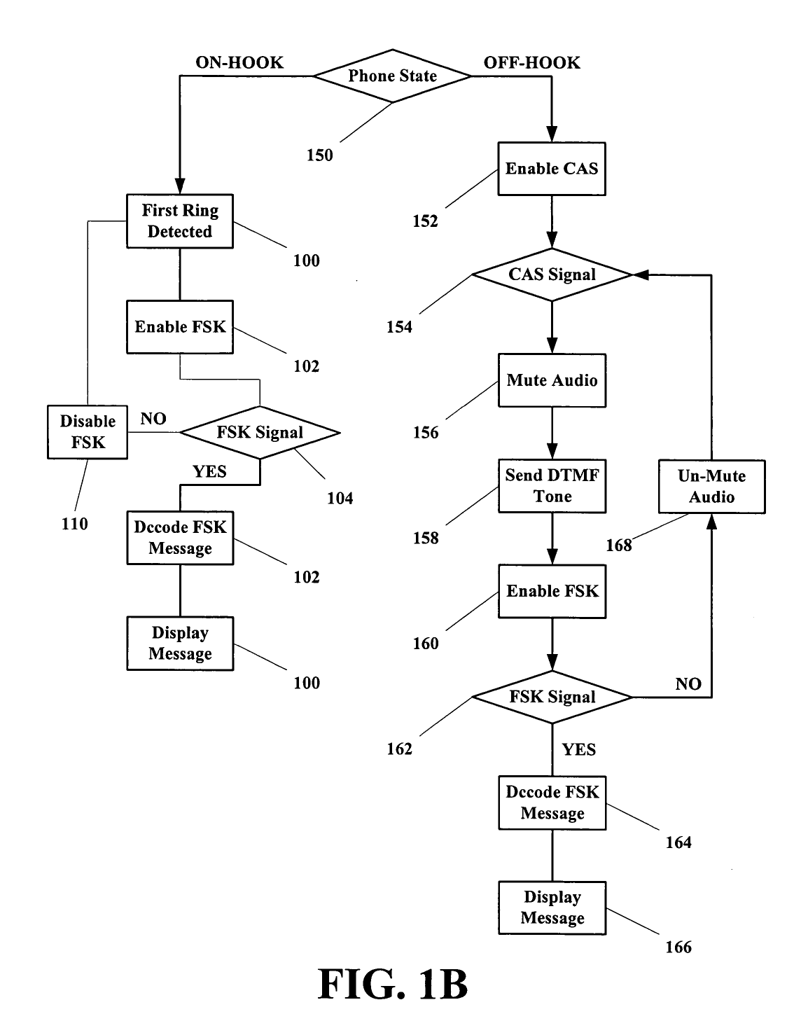

Telecordia Technologies, Inc., Morristown, N.J., originally Bellcore, defined three classes of caller ID services, known respectively as Type I, Type II, and Type III. In a Type I caller ID service, a phone is equipped with a Frequency Shift Key (FSK) detector, a controller, and a display. When a call is placed to the phone, a Stored Program Control System (SPCS) situated within the Public Switched Telephone Network (PSTN) activates a corresponding FSK generator also situated within the PSTN to transmit to the phone an FSK signal encoding caller ID information. At the phone, as indicated in FIG. 1A, when a first ring is detected in a first ring detection step 100, the controller enables an FSK detector in an FSK enable FSK step 102, which listens for an FSK signal. If an FSK signal is detected before the second ring in an FSK detection step 104, then control is transferred along a YES branch of the FSK detection step 104. Next, the FSK signal containing an encoded message is demodulated to obtain caller ID information in a decode step 106. That information is then displayed in a display step 108. If, however, an FSK signal is not detected before the second ring, then control is transferred along a NO branch of the FSK detection step 104, where the FSK detector is disabled in a disable step 110 and back to the first ring detection step 100.

In a Type II or Type III caller ID service, a phone is also equipped with a Customer Premises Equipment Alerting Signal (CAS) detector. When a call is placed to this type of phone, as illustrated in FIG. 1B, the Stored Program Control System (SPCS) first determines if the phone is on-hook or off-hook state in a phone state determination step 150. If the phone is in an on-hook state, then control is transferred along a ON-HOOK branch of step 150 to step 100, because Type II and III phones act as Type I phones when the Type II and III phones are in their on-hook state and the process is as described in FIG. 1A. If the phone is in an off-hook state, then control is transferred along an OFF-HOOK step to an enable CAS step 152, which enables a CAS detector in the phone. When a call is sent to a Type II or III phone equip with a call waiting/caller ID service, the service activates a corresponding CAS generator situated within the PSTN to generate and transmit a CAS signal to the phone. The CAS detector in the phone, which has been previously enabled by the controller in enablement step 152, listens for the CAS signal in a CAS conditional step 154. If the CAS signal is detected, then control is transferred to a mute step 156, where the controller mutes the audio channel of the phone. Next, a Dual Tone Multi-Frequency (DTMF) tone is sent in a DTMF send step 158, which serves as an acknowledgement signal. In the case of a Type II caller ID service, the acknowledgment signal is a DTMF “D” tone; in the case of a Type III unit, the acknowledgment signal is a DTMF “A” tone. Muting of the audio channel is required since an FSK signal in one implementation is transmitted at a range of frequencies, 500-2500 Hz, which is within the audio band of 0 to about 3000 Hz.

The controller then enables the FSK detector in an enablement step 160, which listens for an FSK signal a FSK conditional step 162. If an FSK signal is detected before the expiration of a predetermined timeout period, then control is transferred along a YES branch of the FSK conditional step 162. Next, the FSK signal is demodulated and the caller ID information in a decode message step 164 and the decoded message displayed in an FSK retrieval/display step 166. If there is a timeout before the FSK signal is detected, control is transferred along a NO branch of the FSK conditional step 162 to an un-mute step 168, where the controller then un-mutes the audio channel. Control is then transferred back to the CAS conditional step 154.

As indicated, the process for the Type III service is identical to that of the Type II service, except that the acknowledgement signal is a DTMF “A” tone. This identifies the Customer Premises Equipment (CPE), that is, the “A” tone identifies the phone as a Type III unit.

An Analog Display Services Interface (ADSI) is a Telecordia-defined interface and related protocol for bidirectional transmission of data between a SPCS server and an ADSI-compatible phone. The interface is such that an ADSI-compatible phone is backward compatible with a Type III phone. Data transmission to the phone is achieved via the FSK receiver already present in the phone. In early implementations, data transmission from the phone was achieved by DTMF tones; while in later implementations, an FSK generator was added to a Type III phone, and data transmission from the phone originated from the FSK generator.

### Internet Implementations

The Internet originated from U.S. Government-funded research that made possible a national inter-networked communication system. This work resulted in the development of a set of conventions (protocols) for interconnecting networks and routing information. These protocols are generally referred to as TCP/IP (Transmission Control Protocol/Internet Protocol). The Internet basically comprises several large computer networks joined together over high-speed data links.

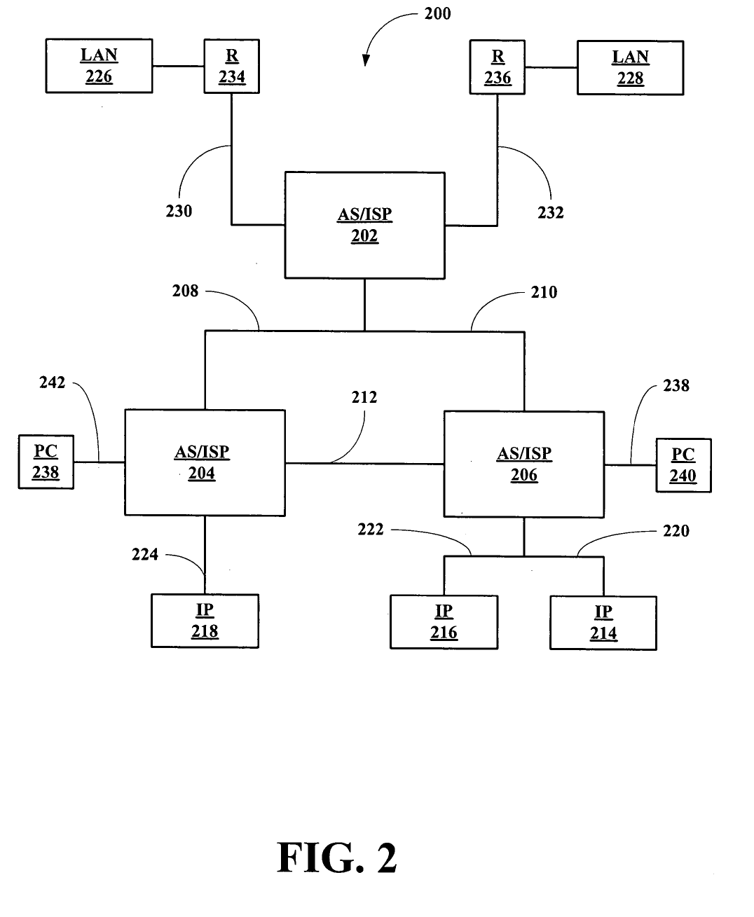

Referring now to FIG. 2, a simplified diagram of the Internet, generally 200, is shown to include Autonomous Systems (AS/ISPs) 202, 204, and 206, which may be operated by Internet Service Providers (ISPs), such as PDQ and America On Line (AOL). Although three AS/ISPs are shown here, it should be recognized that the Internet 200 can support any number of AS/ISPs and in fact, the Internet 200 currently includes hundreds if not thousands of AS/ISPs. The three illustrative AS/ISPs 202, 204 and 206 are linked together by communication links 208, 210 and 212, where the links 208, 210 and 212 may be any wired or wireless means supporting bilateral electronic data transfer such as coaxial cable, fiber optics, traditional telephone wires, twisted pairs, shielded twisted pairs, RF, IR, near IR, microwaver or any other wired or wireless means for transmitting and receiving data. The Internet 200 also includes Information Providers (IPs) 214, 216, and 218. The IPs 214, 216 and 218 can be governmental agencies, universities, companies, charities, foundations, or other repositories of information and data. Again, although only three IPs are shown in FIG. 2, it should be recognized that the Internet 200 currently supports millions of IPs. Like the AS/ISPs, the Ips are linked to the Internet 200 by communication links 220, 222, and 224. Again, the links 220, 222, and 224 can be any communication means set forth for the links 208, 210 and 212 described above. In FIG. 2, IPs 214 and 216 are directly connected to AS/ISP 206 and IPs 218 is connected to AS/ISP 204, it should be recognized that because the AS/ISPs on the Internet are all interconnected via communication links, it is immaterial which IPs is connected to which AS/ISP and the choice shown here is only for illustrative purposes.

The Internet 200 also includes Local Area Networks (LANs) 226 and 228, which may be associated with a company, a university, a charity, a foundation, etc. The LANs 226 and 228 are generally connected to an AS/ISP through communication links 230 and 232 mediated by routers (R) 234 and 236, respectively. The Rs 234 and 236 act as gate keepers and can provide virus protection and fire wall protection. Additionally, the Internet 100 includes remote computers (PCs) 238 and 240, which represent remote computers connected to the Internet via a public switched telephone network (PSTN) to an AS/ISPs via dial up links 242 and 244.

The IPs collect and market information through their own servers. AS/ISPs, which market the usage of their networks, transport the information from the IPs to users who request the information.

The Internet 100 may be viewed as a series of routers connected together, and with computers connected to the routers. In the addressing scheme of the Internet an address comprises a set of four numbers separated by dots, e.g., 164.947.483.492. Each machine on the Internet has a unique address, i.e., a unique set of four three digit number separated by dots. The leftmost number in the address is a highest order number, and is generally referred to as the first number. Typically, the first two numbers will indicate a network or a location. When a packet bearing a destination address leaves a source router it compares the first two numbers of the destination address with a matrix table to determine how many hops are the minimum to get to the destination. Each router has a database table that finds the information automatically. The router then sends the packet to the next router determined from that table and the procedure is repeated. This continues from router to router along the transmission path until the packet arrives at the destination address, typically a computer. The third three digit number, 483 in the example address, identifies a destination router; while the last three digit number identifies a specific computer connected to the destination router, a router network. That router network is connected to the last or destination router in the transport path. In differentiating between two computers in the same destination network, only the last three digit number changes. The separate packets that constitute a message may not travel by the same path across the Internet, because of variations in the Internet traffic load. However, the data packets all reach the same destination and are assembled in their original order in a connectionless fashion.

One of the more frequently used services available on the Internet is electronic mail, or e-mail. Initially, e-mail software only allowed a person using one computer to type a message and to send it across the Internet to a person using another computer. However, current e-mail systems can be used to send a single message to many recipients, send a message that includes text, audio, video, or graphics, send a message to a user on a network outside the Internet, or send a message to which a computer program responds.

Computer communication always involves interaction between two programs called a client and a server. E-mail systems follow the client-server approach: two programs cooperate to transfer an e-mail message from the sender's computer to the recipient's mailbox (transfer requires two programs because an application running on one computer cannot store data directly in a mailbox on another computer's disk). When a user sends an e-mail message, a program on the sender's computer becomes a client. It contacts an e-mail server program on the recipient's computer and transfers a copy of the message. The server stores the message in the recipient's mailbox. The interaction between a client and server is complex because at any time computers or the Internet connecting them can fail (e.g., someone can accidentally turn off one of the computers). To ensure that e-mail will be delivered reliably, the client keeps a copy of the message during the transfer. After the server informs the client that the message has been received and stored on disk, the client may erase its copy.

One or more companies have recently developed software for use on personal computers to permit two-way transfer of real-time voice information via an Internet data link between two personal computers. In one of the directions, the sending computer converts voice signals from analog to digital format. The software facilitates data compression down to a rate compatible with modem communication via a POTS telephone line. The software also facilitates encapsulation of the digitized and compressed voice data into the TCP/IP protocol with appropriate addressing to permit communication via the Internet. At the receiving end, the computer and software reverse the process to recover the analog voice information for presentation to the other party. Such programs permit telephone-like communication between Internet users registered with Internet Phone Servers.

It is contemplated that a service utilizing the present invention may be offered as an enhancement to more standard caller ID services, and that Local, Long Distance or Wireless Telephone Service Providers will offer such services to thier users pursuant to a contract or other arrangement for providing Notification or Emergency Alert Services services.

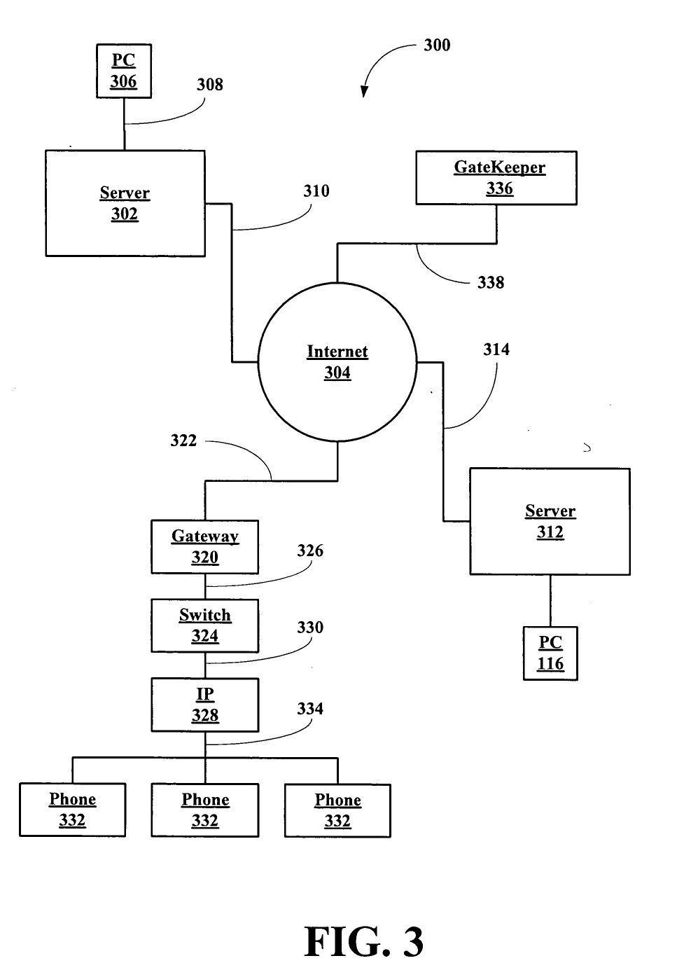

Referring now to FIG. 3, the software needed to implement an emergency alert system of this invention, generally 300, typically resides on a sender server 302. To send messages across the Internet 304, the user will run an e-mail server application program on a local computer (PC) 306 linked to the sender server 302. In order to implement the present invention, appropriate computer code (the “Enhancement Code”) is included in the e-mail server application program on the PC 306. This Enhancement Code will normally be supplied by the Telephone service provider and either included with the initial e-mail server application program installed on the PC 306, or supplied via e-mail service provider as a downloadable upgrade. Those of ordinary skill in the art will understand how to write such Enhancement Code based on the description of the invention herein, and the code will not be discussed in detail herein.

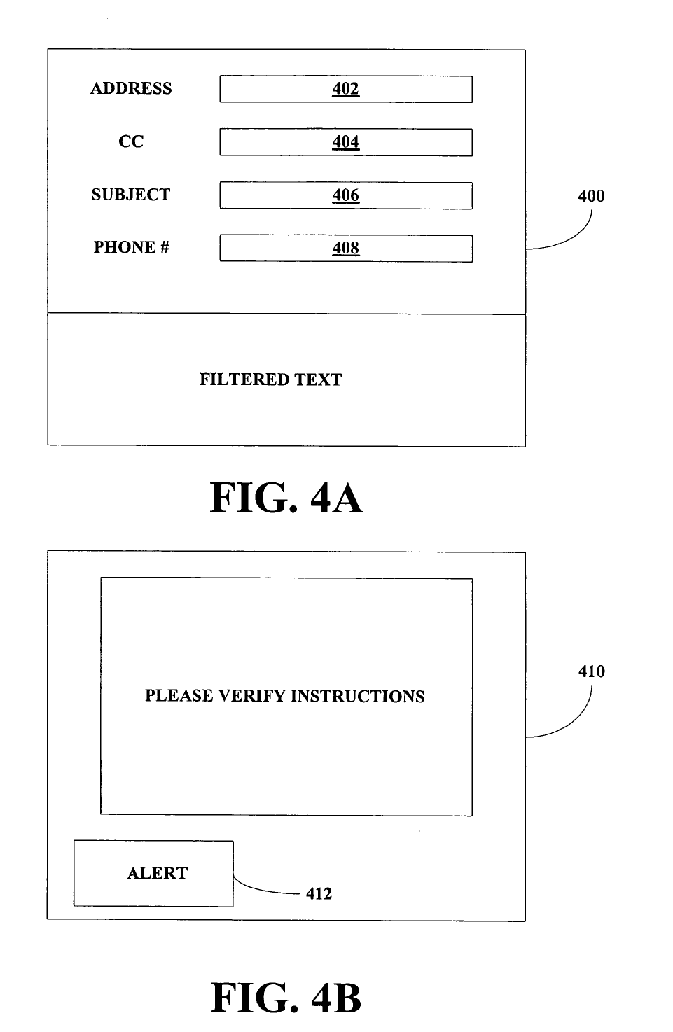

To enable the user to receive alerts, the enhanced e-mail application program will typically display an alter button, which can include a verbal or graphic descriptor such as “Filter Incoming Messages”. The alter button enables the user to choose the e-mail messages for which he/she wants FSK notification or Alerts. Typically, the computer display screen will display a format that indicates to the user the locations for inserting the information needed to complete the e-mail. Looking at FIG. 4A, a preferred embodiment of a display 400 adapted to enter data for the enhancement software. The display 400 includes a recipient address field 402 for inserting the intended recipient's e-mail address, a cc field 404 for inserting any additional e-mail addresses to which the e-mail user desires to activate the filtering software, a subject field 406 for including a subject description for an e-mail message, and, in accordance with the present invention, a phone number field 408 where the e-mail user may insert the telephone number to which the e-mail user desires the alert system to place a telephone call to. The e-mail application program may also provide for the e-mail user to insert a telephone number in this space by clicking on an entry in a personal phone book the user has stored in computer memory. Insertion of a telephone number in the phone number field 408 causes the e-mail server to filter e-mail messages according to the desired criteria determined by the user and subsequently cause a soft switch server to place a call to the designated telephone number and deliver a signal that describes the subject of the message. Looking at FIG. 4B, a typical representation 410 of the e-mail filtering interface on the recipient's display, with the “Alert” button indicated by numeral 412. It is understood that this indication may also be included in the Subject line of the e-mail message.

As shown in FIG. 3, the e-mail message is transmitted from the e-mail sender PC 306 over a communication link 308, which may be a dial up telephone link, or a cable or fiber optic link, to server 302, on which the e-mail service provider's software resides. From the server 302, the e-mail message is transmitted to the Internet 304 via an internet link 310 and through the Internet 304 to a recipient server 312 via another internet link 314. The server 302 has installed thereon the software necessary for the e-mail service provider to furnish e-mail messages. The e-mail message is then transmitted to a recipients PC 316 connected to the second server 312 via a second communication link 318 to be read by the recipient.

Alternatively, the alter message can be forwarded not to a PC as an e-mail message, but can be sent directly to a recipient phone, one equip with either caller ID or call waiting/caller ID. Thus, the alter will be issued from the sender PC 306, through the sender server 302, through the Internet 304 to a gateway 320 via another Internet link 322. The message is then forwarded to a switch 324 via a communication link 326, then to a PST Network 328 via another communication link 330, and finally to three recipient phones 332 via other communication links 334. The system 300 of this invention can also include a gatekeeper 336 via an Internet gatekeeper link 338 for controlling and monitoring in the flow of alter messages to and form designated sites on the Internet.

Thus, the system of this invention utilizes the ability of caller ID enabled phones and enable messages to produce an emergency alter system where messages are encoded for decoding by an FSK detector in the phone and to display the resulting message, then if the caller is on the phone provided that the phone is a Type II or III phone. Moreover, the present invention can be operated by web enabled phones. Thus, instead of sending the message from a PC, the sender can use a web enabled phone to prepare and send the message via its phone network to the Internet for dissemination to designated recipients.

As examples of the present system, a phone or e-mail provider could issue weather alerts to its customers to advise them of weather related conditions. The military could issue command and control orders over appropriated cell phones or other devices capable of receiving and sending messages. Police and fire stations could issue command and control orders to policemen and firemen via cell phones or PCs. Companies could issue meeting notices or other vital information to employees, all or some depending on the recipient list utilized. The civil defense network could issue alters to all phones and PC as a generalized alert mediated via a gatekeeper.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

1. A method for transmitting emergency and other informative messages over a phone line, comprising: installing software into an telephone switch computer or device to enable the telephone switch to place a telephone call which delivers a short message using Frequency Shift Keying (FSK) to a second device that is attached to the telephone line; and wherein the second device includes a caller ID customer premise equipment (CPE) or a modem connected to a computer with software that would enable the user to see (visual) or hear (audible) an alarm related to said message.

2. The method of claim 1 wherein said CPE device is a personal computer.

3. A method as claimed in claim 1, wherein the CPE device is wired or wireless dataphones, telephones, laptop computers, palm pilots, televisions or wireless handsets

4. A method of communication utilizing the Public Switch Telephone Network (PSTN) and the Internet which includes receiving on a database server, a query transmitted from a first computer, which query includes a set of instructions encapsulated in string of data including a telephone number, time, date and a short fifteen character message that will be accessed by a third computer which is running a telephone soft switch server, said soft switch server will then place a call to the said telephone number and deliver the string of data using Frequency Shift Keying (FSK) even while the recipient's phone is ringing or while off hook as call wait caller id (CWCID).

5. The method of claim 4 wherein said database server is further adapted to confirm authentication information supplied in the query about the telephone user receiving the notification message.

6. A method of providing communications, comprising: receiving on a first database server an transmission from an Internet connection device originated by an information content provider, said data input transmission including a data string which is converted to an FSK signal by a second server which retrieves the inputted data from the database server and generates a telephone call to a telephone user and to initiate an FSK signal from the second server to a caller ID Customer Premise Equipment (CPE) or a modem connected to a computer; and delivering a short 16 character to said CPE or modem.

7. The method of claim 6 wherein said second Internet connection device obtains from a database the address of a telephony switch server through which said telephone call may be connected to said telephone number.

8. The method of claim 6 wherein said first Internet connection device is a personal computer.

9. The method of claim 6 wherein said second Internet connection device is a personal computer.
